(19) United States
(12) Patent Application Publication
(10) Pub. No.: US 2017/0017400 A1
(43) Pub. Date: Jan. 19, 2017

(54) MEMORY DEVICE, MEMORY SYSTEM INCLUDING THE SAME AND OPERATION METHOD OF MEMORY DEVICE

(71) Applicant: SK hynix Inc., Gyeonggi-do (KR)

(72) Inventors: Yong-Kee KWON, Gyeonggi-do (KR); Yong-Ju KIM, Gyeonggi-do (KR); Hong-Sik KIM, Gyeonggi-do (KR)

(21) Appl. No.: 14/983,366

(22) Filed: Dec. 29, 2015

(30) Foreign Application Priority Data
Jul. 15, 2015 (KR) 10-2015-0100274

(51) Int. Cl. G06F 3/06

(52) U.S. Cl. CPC G06F 3/0604; G06F 3/0629; G06F 3/0673

(57) ABSTRACT

An operation method of a memory device includes: receiving a computation command; receiving a first address corresponding to the computation command; reading first data from a first memory location designated by the first address; receiving a second address corresponding to the computation command; reading second data from a second memory location designated by the second address; and performing a computation operation corresponding to the computation command on the first and second data.

### CROSS-REFERENCE TO RELATED APPLICATIONS

The present application claims priority of Korean Patent Application No. 10-2015-0100274, filed on Jul. 15, 2015, which is incorporated herein by reference in its entirety.

### BACKGROUND

1. Field

Various embodiments of the present invention relate to a memory device, a memory system including the same, and an operation method thereof.

2. Description of the Related Art

Generally, a memory system includes a memory device and a memory controller. The memory system may be used in a computing system.

FIG. 1 is a diagram illustrating a conventional computing system.

Referring to FIG. 1, the conventional computing system includes a central processing unit (CPU) 130, a memory controller 110, and a memory device 1211 The memory device 120 stores data (i.e., values). The CPU 130 performs a computation, and the memory controller 110 controls the memory device 120 according to a request from the CPU 130.

FIG. 2 is a diagram illustrating an operation of the computing system shown in FIG. 1. FIG. 2 shows a process of generating a value ‘Z’ by adding values ‘X’ and ‘Y’ (i.e., X+Y=Z) that are stored in the memory device 120 as an example.

At step S201, the CPU 130 transmits a request signal to the memory controller 110 indicating that data stored at an address ‘A’ of the memory device 120 is to be accessed. The memory controller 110 transmits a read command and the address ‘A’ to the memory device 120 at step S203. Then, the memory device 120 reads the value ‘X’ from the A address and transmits the read value to the memory controller 110 at step S205, and the memory controller 110 transmits the X value to the CPU 130 at step S207.

At step S209, the CPU 130 transmits a request signal indicating that data stored at an address ‘B’ of the memory device 120 is to be accessed, to the memory controller 110. The memory controller 110 transmits a read command and the “B” address to the memory device 120 at step S211. Then, the memory device 120 reads the value ‘Y’ from the address ‘B’ and transmits the read value to the memory controller 110 at step S213, and the memory controller 110 transmits the value ‘Y’ to the CPU 130 at step S215.

At step S217, the CPU 130 performs a computation to generate a value ‘Z’ by adding the values ‘X’ and ‘Y’. Then, the CPU 130 transmits a request signal to the memory controller 110, to request the memory controller 110 to store the value ‘Z’ at an address ‘C’, at step S219. At step S221 the memory controller 110 transmits a write command, the address ‘C’ and the value ‘Z’ to the memory device 120. Then, the memory device 120 writes the value ‘Z’ to the address ‘C’ at step S223.

So even for performing a very simple computation, multiple commands and data must be exchanged among the CPU 130, the memory controller 110, and the memory device 120. Thus, performance of the computing system is degraded, and power consumption increased.

### SUMMARY

Various embodiments of the present invention are directed to a memory device, system and operation thereof having improved performance and reduced power consumption. The memory device and system may be used with any suitable computing system making the computing system more efficient and reducing its power consumption requirements. The memory device may be used with any suitable device, such as an electronic device, including portable electronic devices such as smart phones. The memory device may be a semiconductor memory device implemented on an integrated chip.

An operation method of a memory device, the method including: receiving a computation command; receiving a first address corresponding to the computation command; reading first data from a first memory location designated by the first address; receiving a second address corresponding to the computation command; reading second data from a second memory location designated by the second address; and performing a computation operation corresponding to the computation command on the first and second data,

The first and second memory locations may be one or more memory cells in a memory cell array.

At least one of the first or second addresses may comprise a column and a row address received from the memory device at different times.

The operation method may include receiving a third address corresponding to the computation command and writing the result of the computation operation to memory cells designated by the third address.

The operation method may include outputting the result of the computation operation to a device external to the memory device,

The computation command may be received when the first address i received, when the second address is received, and/or when the third address is received.

The computation command may include any suitable command such as, for example, an addition command, a subtraction command, a multiplication command, an OR operation command, an XOR operation command, an AND operation command, and the like

According to an embodiment of the invention, a memory system may include: a memory controller and a memory, the memory controller suitable for generating a computation command and first and second addresses corresponding to the computation command; and the memory device suitable for reading first data and second data from a first and second memory locations designated by the first and second address, respectively, and for performing a computation operation corresponding to the computation command on the first and second data.

The memory controller may further transmit a third address corresponding to the computation command to the memory, and the memory may write the result of the computation operation to memory cells corresponding to the third address.

The memory may transmit the result of the computation operation to the memory controller after performing the computation operation.

The computation command may include any suitable command such as, for example an addition command, a subtraction command, a multiplication command, an OR operation command, an XOR operation command, an AND operation command and the like

An example of a suitable memory may include: a cell array; an access circuit suitable for reading data stored in the cell array or writing data to the cell array; a first register suitable for storing the first data read by the access circuit; a second register suitable for storing the second data read by the access circuit; a computation circuit suitable for performing a computation operation corresponding to the computation command on the first data stored in the first register and the second data stored in the second register; and a third register suitable for storing the computation result of the computation circuit, and providing the computation result to the access circuit such that the computation result is written to the memory cells corresponding to the third address in the cell array.

Another example, of a suitable memory may include: a cell array; an access circuit suitable for reading data stored in the cell array or writing data to the cell array; a first register suitable for storing the first data read by the access circuit; a second register suitable for storing the second data read by the access circuit; a computation circuit suitable for performing a computation operation corresponding to the computation command on the first data stored in the first register and the second data stored in the second register, a third register suitable for storing the computation result of the computation circuit; and an output circuit suitable for outputting the computation result stored in the third register.

### BRIEF DESCRIPTION OF THE DRAWINGS

FIG. 1 is a diagram illustrating a conventional computing system.

FIG. 2 is a diagram for describing an operation of the conventional computing system shown in FIG. 1.

FIG. 3 is a diagram illustrating a memory system, according to an embodiment of the present invention.

FIGS. 4 and 5 are diagrams illustrating an operation of the memory system shown in FIG. 3, according to an embodiment of the present invention.

FIG. 6 is a diagram of a memory device illustrate in FIG. 3, according to an embodiment of the present invention.

FIGS. 7 and 8 are diagrams illustrating an operation of the memory system shown in FIG. 3, according to an embodiment of the present invention.

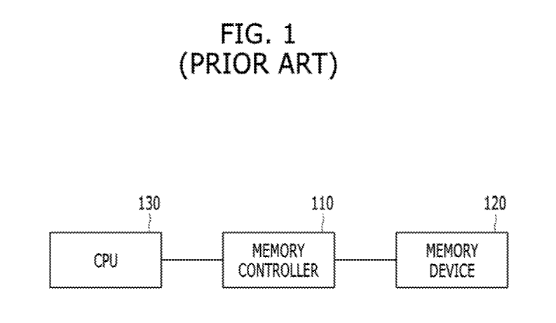

### DETAILED DESCRIPTION

Various embodiments will be described below in more detail with reference to the accompanying drawings. The present invention may, however, be embodied in different forms and should not be construed as limited to the embodiments set forth herein. Rather, these embodiments are provided so that this disclosure will be thorough and complete. Throughout the disclosure, like reference numerals refer to like parts throughout the various figures and embodiments of the present invention.

The drawings are not necessarily to scale and, in some instances, proportions may have been exaggerated to clearly illustrate features of the embodiments. It is also noted that in this specification, “connected/coupled” refers to one component not only directly coupling another component, but also indirectly coupling another component through an intermediate component

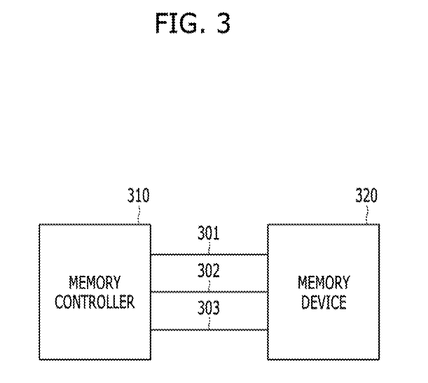

FIG. 3 is a diagram illustrating a memory system in accordance with an embodiment of the present invention.

Referring to FIG. 3, the memory system may include a memory controller 310 and a memory device 320 also referred to herein simply as a memory.

The memory controller 310 may control the memory device 320 through a command channel 301, an address channel 302, and a data channel 303. The memory controller 310 may control read and write operations of the memory device 320 through the channels 301 to 303. The memory controller 310 may control a computation operation of the memory device 320 through the channels 301 to 303. Each of the channels 301 to 303 may include a plurality of transmission lines.

The memory device 320 may be controlled through the command channel 301, the address channel 302, and the data channel 303. The memory device 320 may perform read and write operations. For example when a read command s received through the command channel 301, the memory device 320 may read data from memory cells corresponding to an address received through the address channel 302, and transmit the read data to the memory controller 310 through the data channel 303. Furthermore, when a write command is received through the command channel 301, the memory 320 device may write data received through the data channel 303 to memory cells corresponding to an address received through the address channel 302. The memory device 320 may perform a computation operation under the control of the memory controller 310. The memory device 320 may be or comprise any suitable memory device such as, for example, DRAM (Dynamic Random Access Memory), NAND Flash memory, NOR Flash memory, RRAM (Resistive Random Access Memory), PRAM (Phase-change Random Access Memory), FRAM (Ferroelectric Random Access Memory), MRAM (Magnetic Random Access Memory), E-fuse, SRAM (Static Random. Access Memory), and the like.

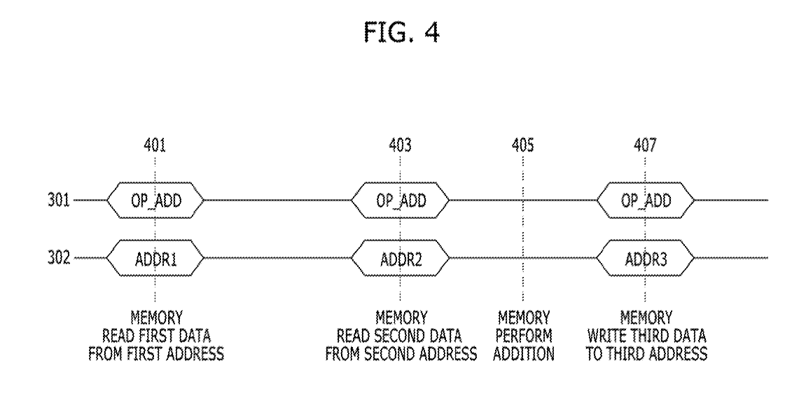

FIG. 4 shows an example of a computation operation of the memory system shown in FIG. 3.

Referring to FIG. 4, an addition command OP_ADD and a first address ADDR1 may be transmitted to the memory device 320 from the memory controller 310 at a time point 401. Then the memory device 320 may read data from memory cells corresponding to the first address ADDR1, and temporarily store the read data without transmitting the read data to the memory controller 310. Hereafter, the data will be referred to as first data.

At a time point 403, the addition command OP_ADD and a second address ADDR2 may be transmitted to the memory device 320 from the memory controller 310. Then, the memory device 320 may read data from memory cells corresponding to the second address ADDR2 and temporarily store the read data without transmitting the read data to the memory controller 310. Hereafter, the data will be referred to as second data. The addition command O_PADD at the time point 403 may be inputted to the memory device 320 to indicate that the second address ADDR is related to the addition command OP_ADD. Since the addition command OP_ADD is inputted to the memory device 320 at the time point 401, it may indicate that the second address ADDR2 inputted at the time point 403 is also related to the addition command OP_ADD. Thus, the input of the addition command OP_ADD to the memory device 320 at the time point 403 may be omitted.

At a time point 405, the memory device 320 may add the first and second data, and temporarily store the addition result (hereafter, referred to as third data).

At a time point 407, a third address ADDR3 and the addition command OP_ADD may be transmitted to the memory device 320 from the memory controller 310. Then, the memory device 320 may write the third data to memory cells corresponding to the third address ADDR3. The addition command OP_ADD at the time point 407 may be inputted to the memory device 320, to indicate that the third address ADDR3 is related to the addition command OP_ADD. Since the addition command OP_ADD is inputted to the memory device 320 at the time point 401, it may indicate that the third address ADDR3 inputted at the time point 407 is also related to the addition command OP_ADD. Thus, the input of the addition command OP_ADD to the memory device 320 at the time point 407 may be omitted.

Since the third data as the addition result for the memory cells corresponding to the third address ADDR3 is stored in the memory device 320, the memory controller 310 may acquire the third data by instructing the memory device 320 to perform a read operation for the third address ADDR3 whenever the third data is required.

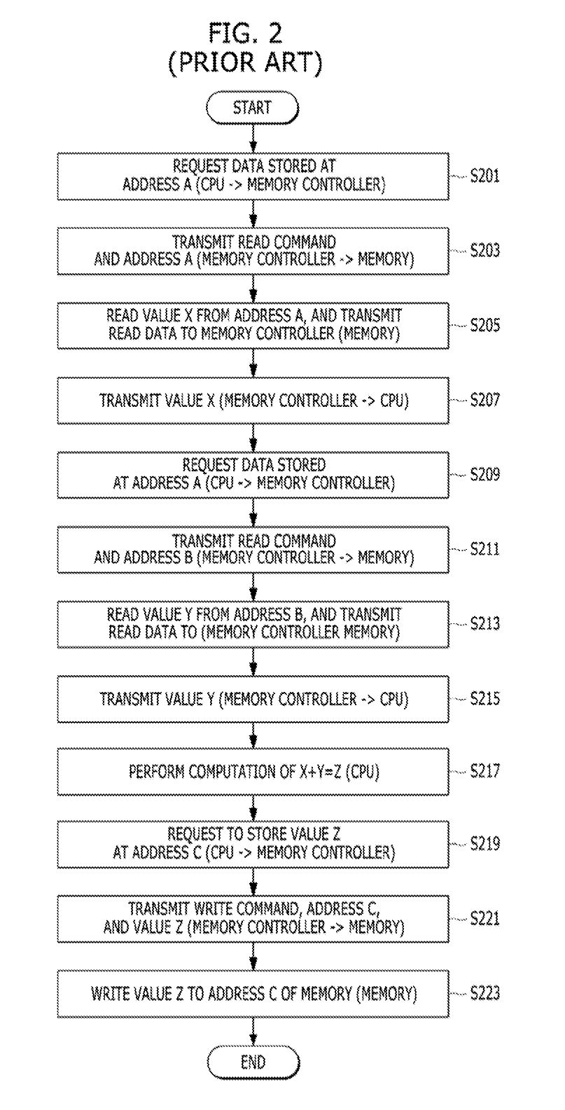

Referring to FIG. 4, as the addition command OP_ADD and three addresses ADDR1, ADDR2, and ADDR3 are inputted to the memory device 320 from the memory controller 310, the first data stored at the first address ADDR1 and the second data stored at the second address ADDR2 may be added, and the third data as the addition result may be written to the third address ADD3. As the memory device 320 performs a simple computation operation for itself, the complex process as illustrated in FIG. 2 may be significantly simplified. As a result, the performance of the memory system may be improved and its power consumption reduced.

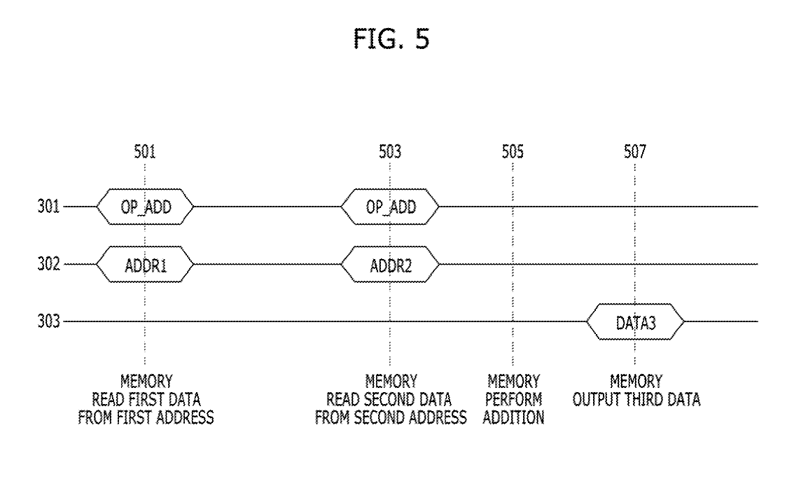

FIG. 5 shows another example of a computation operation of the memory system shown in FIG. 3.

Referring to FIG. 5, an addition command OP_ADD and a first address ADDR1 may be transmitted to the memory device 320 from the memory controller 310 at a time point 501. Then, the memory device 320 may read data from memory cells corresponding to the first address ADR, and temporarily store the read data without transmitting the read data to the memory controller 310, Hereinafter, the data from memory cells corresponding to first address ADDR1 may &so be referred to as first data.

At a time point 503, the addition command OP_ADD and a second address ADDR2 may be transmitted to the memory device 320 from the memory controller 310. Then, the memory device 320 may read data from memory cells corresponding to the second address ADDR2, and temporarily store the read data without transmitting the read data to the memory controller 310. Hereafter, the data from memory cells corresponding to the second address ADDR2 may also be referred to as second data. The addition command OP_ADD at the time point 503 may be inputted to the memory device 320, to indicate that the second address ADDR2 is related to the addition command OP_ADD. However, since the addition command OP_ADD is inputted to the memory device 320 at the time point 501 this may indicate that the second address ADDR2 inputted at the time point 503 is also related to the addition command OP_ADD. Thus, the input of the addition command OP_ADD to the memory device 320 at the time point 503 may be omitted.

At a time point 505, the memory device 320 may add the first and second data, and temporarily store the addition result, hereafter, referred to also as third data.

At a time point 507, the memory device 320 may transmit the third data DATA3 to the memory controller 310 through the data channel 303.

In the example of FIG. 4, it has been described that the addition command OP_ADD and the three addresses ADDR1 to ADDR3 are transmitted to the memory device 320, and the memory device 320 adds the first data corresponding to the first address ADDR1 and the second data corresponding to the second address ADDR2 and stores the third data as the addition result into the memory cells corresponding to the third address ADDR3. In the example of FIG. 5, however, the addition command OP_ADD and the two addresses ADDR1 and ADDR2 may be transmitted to the memory device 320, and the memory device 320 may add the first data corresponding to the first address ADDR1 and the second data corresponding to the second address ADDR2, and directly transmit the third data as the addition result to the memory controller 310.

In the embodiment of FIG. 5, as the memory device 320 performs a simple computation operation by itself, the complex process as illustrated in FIG. 2 may also be significantly simplified. As a result, the performance of the memory system may be improved, and the power consumption of the memory system may be reduced.

FIGS. 4 and 5 illustrate the operation process of the addition in the memory device 320. However, other computation operations, such as a subtraction, a multiplication, an OR operation, an XOR operation, and the like, may be performed in the same manner.

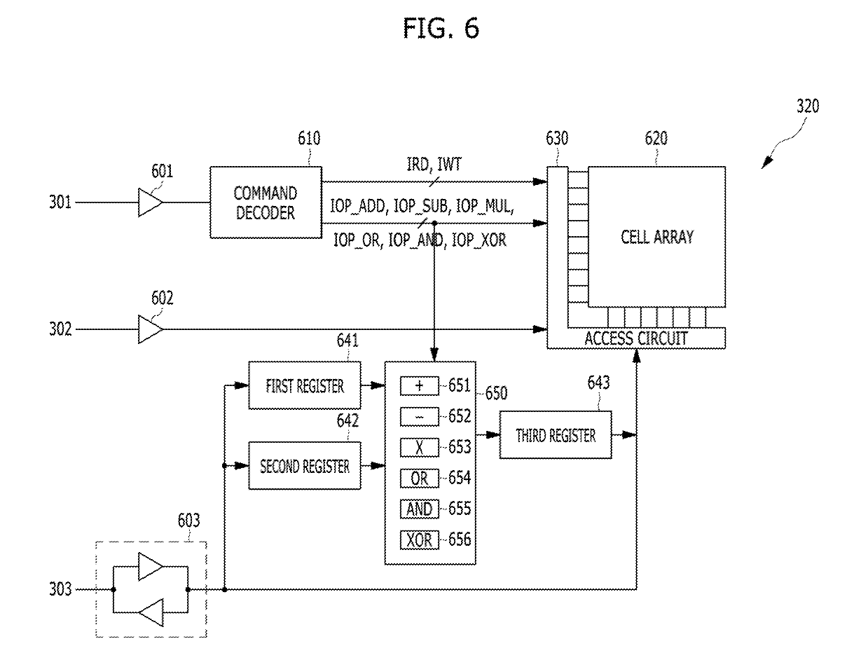

FIG. 6 is a more detailed diagram of the memory device 320 illustrated in FIG. 3, according to an embodiment of the invention.

Referring to FIG. 6, the memory device 320 may include a command receiver 601, an address receiver 602, a data transmitter/receiver 603, a command decoder 610, a cell array 620, an access circuit 630, a first register 641, a second register 642, a third register 643, and a computation circuit 650.

The command receiver 601 may receive a command transmitted through the command channel 301 from the memory controller 310. The address receiver 602 may receive an address transmitted through the address channel 302 from the memory controller 310. The data transmitter/receiver 603 may receive data transmitted through the data channel 303 from the memory controller 310 or transmit data to the memory controller 310 through the data channel 303.

The command decoder 610 may decode the command received through the command receiver 601, and generate an internal read command IRD, an internal write command IWT, and internal commands IOP_ADD, IOP_SUB, IOP_MUL, IOP_OR, IOP_AND, and IOP_XOR, The internal read command IRD may indicate a read operation of the memory device 320, and the internal write command IWT may indicate a write operation of the memory device 320. The internal commands IOP_ADD, IOP_SUB, IOP_MUL, IOP_OR, IOP_AND, and IOP_XOR may command the memory device 320 to perform a computation operation. The internal addition command IOP_ADD may command the memory device 320 to perform an addition, the internal subtraction command IOP_SUB may command the memory device 320 to perform a subtraction and the internal multiplication command IOP_MUL may command the memory device 320 to perform a multiplication. The internal OR operation command IOP_OR may command the memory device 320 to perform an OR operation, the intern& AND operation command IOP_AND may command the memory device 320 to perform an AND operation, and the internal XOR operation command IOP_XOR may command the memory device 320 to perform an XOR operation.

The cell array 620 may include a plurality of memory cells arranged in a plurality of rows and columns.

The access circuit 630 may access one or more memory cells in the cell array 620 during a read/write operation, the memory cells corresponding to an address received through the address receiver 602. During the read operation, data read by the access circuit 630 may be outputted outside of the memory device 320 through the data transmitter/receiver 603. During the write operation, data received through the data transmitter/receiver 603 may be written into the cell array 620 by the access circuit.

During a computation operation in which one of the internal computation commands IOP_ADD, IOP_SUB, IOP_MUL, IOP_OR, IOP_AND, and IOP_XOR is activated, the access circuit 630 may read data (first data) from memory cells corresponding to an address which is received for the first time or example, the first address ADDR1 of FIGS. 4 and 5), and transmit the first data to the first register 641. Then, the access circuit 630 may read data (second data) from memory cells corresponding to an address which is received for the second time (for example, the second address ADDR2 of FIGS. 4 and 5), and transmit the second data to the second register 642. When the memory device 320 performs a computation operation according to the r Method illustrated in FIG. 4, the access circuit 630 may write an operation result stored in the third register 643 to memory cells corresponding to an address which is received for the third time (for example, the third address ADDR3 of FIG. 4).

The first register 641 may store the first data read from the memory cells corresponding to the first address ADDR1 during a computation operation. The first register 641 may be designed to store data which are read from the memory device 320. For example, when 8-bit data are read during one read operation, the first register 641 may be designed to store at least 8-bit data.

The second register 642 may store the second data read from the memory cells corresponding to the second address ADDR2 during the computation operation. The second register 642 may have the same data storage capacity as the first register 641.

The third register 643 may store the computation result of the computation circuit 650. The third register 643 may have the same data storage capacity as the first register 641. When the memory device 320 is operated as illustrated in FIG. 4, the data stored in the third register 643 may be provided to the access circuit 630, and written to the memory cells corresponding to the third address ADDR during the computation operation. When the memory device 320 is operated as illustrated in FIG. 5, the data stored in the third register 643 may be provided to the data transmitter/receiver 603, and transmitted to the memory controller 310 through the data transmitter/receiver 603.

The computation circuit 650 may perform a computation on the first data stored in the first register 641 and the second data stored in the second register 642, and store the computation result in the third register 643. The computation circuit 650 may include an adder 651, a subtractor 652, a multiplier 653, an OR operation unit 654, an AND operation unlit 655, and an XOR operation unit 656. The computation circuit 650 may perform a selected computation on the first and second data, and generate the third data. For example, when the internal subtraction command IOP_SUB is activated, a computation of (first data-second data) may be performed by the subtractor 652 of the computation circuit 650. Furthermore, when the internal OR operation command IOP_OR is activated, an OR operation on the respective bits of the first data and the respective bits of the second data may be performed by the OR operation unit 554 of the computation circuit 650. For example, when the first data is 1010 and the second data is 0010, data of 1010 may be generated. Although it has been described that the computation circuit 650 performs an addition subtraction, multiplication, OR operation, AND operation, or XOR operation, the number of types of computations performed by the computation circuit 650 may vary.

The memory device 320 may support only one or both of the computation methods of FIGS. 4 and 5. The memory device 320 may support selecting a mode of operation that supports one or both of the computation methods of FIGS. 4 and 5.

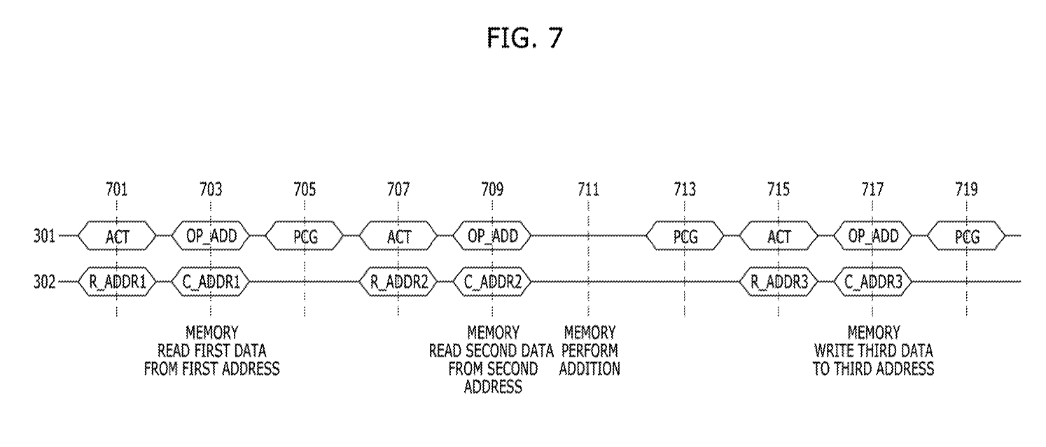

FIG. 7 illustrates an operation method which is modified as compared to the operation method shown in FIG. 4 to account for when a row address and a column address may be received at different times (for example, as in DRAM).

In FIG. 4, it has been described that the first address ADDR1 (i.e., actually a row address and a column address) related to an addition command OP_ADD was inputted at once. Referring to FIG. 7, however, the first address ADDR1 related to an addition command OP_ADD may be received through three separate operations in which an active command ACT and a row address R_ADDR1 of the first address are received at a time point 701, the addition command OP_ADD and a column address C_ADDR1 of the first address are received at a time point 703, and a precharge command PCG for deactivating the row selection by the row address R_ADDR1 of the first address is received at a time point 705.

Similarly, the second address ADDR2 may be received through three separate operations in which an active command ACT and a row address R_ADDR of the second address are received at a time point 707, the addition command OP_ADD and a column address C_ADDR2 of the second address are received at a time point 709, and the precharge command PCG is received at a time point 713. Furthermore, an addition may be performed at a time point 711 between the time point 709 at which the addition command OP_ADD is received and the time point 713 at which the precharge command PCG is received.

Furthermore, the third address ADDR3 may also be received through three separate operations in which an active command ACT and a row address R_ADDR3 of the third address are received at a time point 715, the addition command OP_ADD and a column address C_ADDR3 of the third address are received at a time point 717, and the precharge command PCG is received at a time point 719.

The operation of FIG. 7 may be performed in the same manner as the operation of FIG. 4, except that the first to third addresses ADDR1 to ADDR3 are not received at the same time, but the row addresses and the column addresses are received at different times.

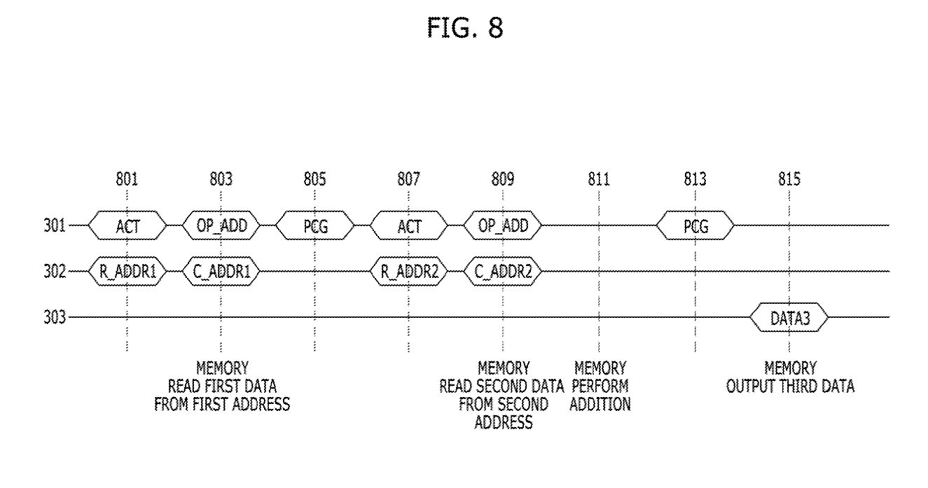

FIG. 8 illustrates a modified operation method compared to the method shown in FIG. 5, which accounts for the situation when a row address and a column address may be received at different times (for example, as in DRAM).

In FIG. 5, it has been described that the first address ADDR1 related to the operation command OP_ADD was inputted at once. Referring to FIG. 8 however, the first address ADDR1 related to the addition command OP_ADD may be received through three separate operations in which an active command ACT and a row address R_ADDR1 of the first address are received at a time point 801, the addition command OP_ADD and a column address C_ADDR1 of the first address are received at a time point 803, and a precharge command PCG for deactivating the row selection by the row address R_ADDR1 of the first address is received at a time point 805.

Similarly, the second address ADDR2 may be received through three separate operations in which an active command ACT and a row address R_ADDR of the second address are received at a time point 807, the addition command OP_ADD and a column address C_ADDR2 of the second address are received at, a time point 809, and the precharge command PCG is received at a time point 813. Furthermore, an addition may be performed at a time point 811 between the time point 809 at which the addition command OP_ADD is received and the time point 813 at which the precharge command is received, and the addition result (i.e., third data) may be temporarily stored.

At a time point 815, the memory device 320 may transmit the third data to the memory controller 310 through the data channel 303.

The operation shown in FIG. 8 may be performed in the same manner as the operation shown in FIG. 5, except that the first and second addresses ADDR1 and ADDR2 are not received at the same time, but the row addresses and the column addresses are received at different times.

In accordance with the embodiments of the invention described herein, the memory device may perform a computation operation, the performance of the memory system may be improved, and the power consumption of the memory system may be reduced.

Although various embodiments have been described for illustrative purposes, it will be apparent to those skilled in the art that various changes and modifications may be made without departing from the spirit and scope of the invention as defined in the following claims.

What is claimed is:

1. An operation method of a memory device., the method comprising:
receiving a computation command;
receiving a first address corresponding to the computation command;
reading first data from a first memory location designated by the first address;
receiving a second address corresponding to the computation to command;
reading second data from a second memory location designated by the second address; and
performing a computation operation corresponding to the computation command on the first and second data.

2. The operation method of claim 1, wherein the first and second memory locations are one or more memory cells in a memory cell array.

3. The operation method of claim 1, wherein at least one of the first or second addresses comprise a column and a row address received at a different point of time.

4. The operation method of claim 1, further comprising receiving a third address corresponding to the computation command and writing a result of the computation operation to memory cells designated by the third address.

5. The operation method of claim 1, further comprising externally outputting a result of the computation operation.

6. The operation method of claim 1, wherein the computation command is received when the first address is received and when the second address is received.

7. The operation method of claim 4, wherein the computation command is received when the first address is received, when the second address is received, and when the third address is received.

8. The operation method of claim 1, wherein the computation command comprises any one of an addition command, a subtraction command, a multiplication command, an OR operation command, an XOR operation command, and an AND operation command.

9. A memory system comprising:
a memory controller suitable for generating a computation command and first and second addresses corresponding to the computation command; and
a memory device suitable for reading first data and second data from a first and second memory locations designated by the first and second address, respectively, and performing a computation operation corresponding to the computation command on the first and second data.

10. The memory system of claim 9, wherein the memory controller transmits a third address corresponding to the computation command to the memory device, and
the memory writes a result of the computation operation to a third memory location corresponding to the third address.

11. The memory system of claim 9, wherein the memory transmits a result of the computation operation to the memory controller.

12. The memory system of claim g, wherein the computation command comprises an addition command, a subtraction command, a multiplication command, an OR operation command, an XOR operation command, an AND operation or a combination thereof.

13. The memory system of claim 9, wherein the first, second and third memory locations are one or more cells in a memory cell array.

14. The memory system of claim 9, where at least one of the first and second addresses comprise a column and a row address received at a different point of time.

15. The memory system of claim 10, wherein the memory device comprises:
a cell array;
an access circuit suitable for reading data stored in the cell array, and writing data into the cell array;
a first register suitable for storing the first data read by the access circuit;
a second register suitable for storing the second data read by the access circuit;
a computation circuit suitable for performing a computation operation corresponding to the computation command on the first: data stored in the first register and the second data stored in the second register; and
a third register suitable for storing a computation result of the computation circuit, and providing the computation result to the access circuit such that the computation result is written into the memory cells corresponding to the third address of the cell array,

16. The memory system of claim wherein the memory device comprises:
a cell array;
an access circuit suitable for reading data stored in the cell array, and writing data into the cell array;
a first register suitable for storing the first data read by the access circuit;
a second register suitable for storing the second data read by the access circuit;
a computation circuit suitable for performing a computation operation corresponding to the computation command on the first data stored in the first register and the second data stored in the second register;
a third register suitable for storing a computation result of the computation circuit; and
an output circuit suitable for externally outputting the computation result stored in the third register.

17. A memory device comprising:
a cell array;
an access circuit suitable for reading data stored in the cell array, and writing data into the cell array;
a first register suitable for storing the first data read by the access circuit;
second register suitable for storing the second data read by the access circuit;
a computation circuit suitable for receiving a computation command, and performing a computation operation corresponding to the computation command on the first data stored in the first register and the second data stored in the second register; and
a third register suitable for storing a computation result of the computation circuit.

18. The memory device of claim wherein the third register provides the computation result to the access circuit such that the computation result is written into the memory cells corresponding to the third address of the cell array.

19. The memory device of claim 13, further comprising an output circuit suitable for externally outputting the computation result stored in the third register.
